(19) United States
(12) Patent Application Publication
(10) Pub. No.: US 2004/0148519 A1
(43) Pub. Date: Jul. 29, 2004

(54) Sensitive data retrieval system and method

(75) Inventor: John Graves, Excelsior, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Convey Development, Inc.

(21) Appl. No.: 10/352,545

(22) Filed: Jan. 28, 2003

(51) Int. Cl. H04L 9/00

(52) U.S. Cl. 713/201

(57) ABSTRACT

An account statement contains a key that is utilized to provide access to selected information in an account. The key and account identification is provided to a document server by a user in the form of a request. The selected information is accessed by the document server, which is only allowed to access information associated with the key. The server populates a document with the information in one embodiment and sends the document back to the user. An application the user is running may use the document to populate a form, such as a tax related document. In one embodiment, a hosting company for an account generates the key, and provides it on an account summary provided to the user. The key may be emailed or otherwise communicated to the user by the account hosting company.

### FIELD OF THE INVENTION

The present invention relates to sensitive data, and in particular to a sensitive data retrieval system and method.

### BACKGROUND OF THE INVENTION

Filling out forms, such as tax forms or other forms sometimes requires information that is held in an electronic account on a network. Many such accounts contain passwords or PINs (Personal Identification Number/s) allowing access to the information in the account. Using these passwords allows the user to obtain information in the account with which to populate the form. The forms reside in a program, such as a tax preparation program which may be running locally, or on a server on the network. It is not desirable to give out a PIN for accounts, as they may be taken and used to a user's detriment and opens access to their full account.

### SUMMARY OF THE INVENTION

An account statement contains a key that is utilized to provide access to selected information in an account. In one embodiment, the key and account identification is provided to a document server by a user. The account is accessed by the document server, which is only allowed to access information associated with the key. The server compiles the associated information in one embodiment and sends the associated information back to the user. An application the user is running may use the associated information to populate a form, such as a tax related document.

In one embodiment, a hosting company for an account generates the key, and provides it on an account summary provided to the user. Since the account statement likely contains the information accessible by the key, minimal further security issues are raised by use of the key to obtain the information for the document. In further embodiments, the key may be emailed or otherwise communicated to the user by the account hosting company.

### BRIEF DESCRIPTION OF THE DRAWINGS

FIG. 1 is a block flow diagram of a process and system for creating documents with information from one or more accounts using an information specific key.

FIG. 2 is a block diagram of a request for creating a document with information from an account.

FIG. 3 is a block flow diagram of an alternative process and system.

FIG. 4 is a block diagram of a typical computer system used in the process and system illustrated in FIG. 1.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples. The software is executed on a digital signal processor, ASIC (Application Specific Integrated Circuit), microprocessor, or other type of processor operating on a computer system, such as a personal computer, server or other computer system.

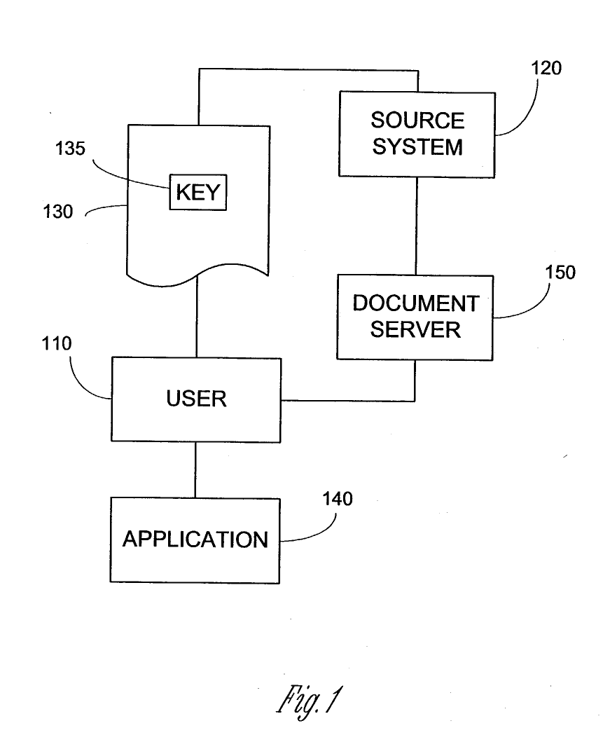

A block diagram showing use of a key or authentication code to obtain specific information from an electronic account is shown in FIG. 1. A user identified at 110 is an owner of an account, such as a bank account or other investment account that is electronically housed on a source system 120, such as an administrative system for on-line banking. The user and source system blocks are representative of both the legal entities of user and bank, and of computer systems that exchange information. The source system 120 in one embodiment communicates a statement 130 to the user, identifying activity in the account, such as interest earned, or other gains from financial instruments in the account. The statement has normal account information, and also includes a key 135 that is specific to a subset of information in the account. If the statement is paper, the key is printed on the statement. The key may be provided in any manner desired by the source system, including orally or electronically.

In one embodiment, the user is executing an application 140 that requires the subset of information to properly perform a function, such as tax preparation and personal financial management software. The application may be running on a server, or on user 110. User 110 generates a request for the information and sends the request to a document server 150. The request contains the key, and enables the document server to access the desired subset of information from the account on the source system 120. When the subset of information is received by the document server, it provides the information back to the user 110 for use in the application 140. In one embodiment, the document server generates an electronic document, such as a tax form comprising a W-2/1099/1098 form. Such forms are defined by one of many open financial exchange protocols, such as OFX, FIX, GSTP, RITD, OMGEO, EMX, SWIFT, FIXML, and FPML. The document is readable by a computer system, may be viewed by the computer system, or even printed if desired in some embodiments. In further embodiments, the document is produced by the source system 120, and passed back to the user directly, or via document server 150.

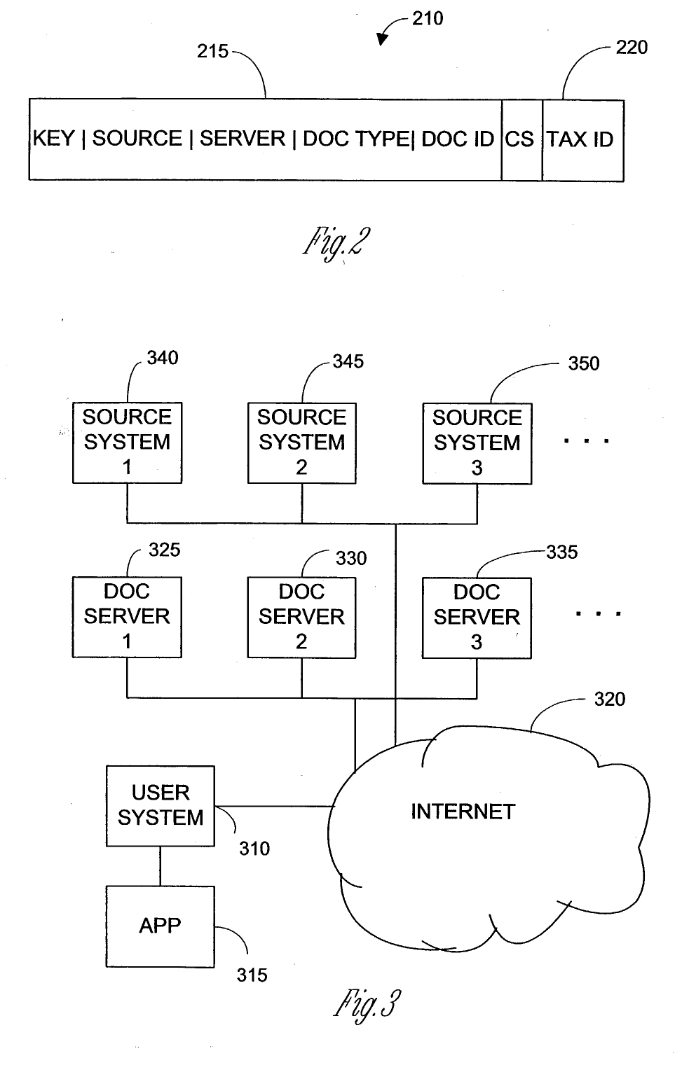

A block diagram of a request is shown in FIG. 2 at 210. The request includes the key, a source identifier, document server identifier, document type, document ID and a check digit at 215, and an account identifier, such as a tax ID or account number at 220. In one embodiment, the request is encoded. Request generation functions are executed on user 110. In one embodiment, the request generation functions are provided by application 140, but may also be a stand alone application, interfacing with one or more applications. A simple user interface is provided for entry of the key. Other information for the request may be provided by a user, or taken directly from the applications, which have the information about the account or accounts. The key is used to allow access to a specific subset of information, such as information required to generate a single form, or multiple forms if desired. It does not provide access to other information or functions provided by the source system with respect to the account, thus, maintaining a desired level of security. In one embodiment, the subset of information that the key allows access to is essentially included in the statement or communication providing the key to the user. Thus, no further information may be gained by theft of the statement containing the key in some embodiments.

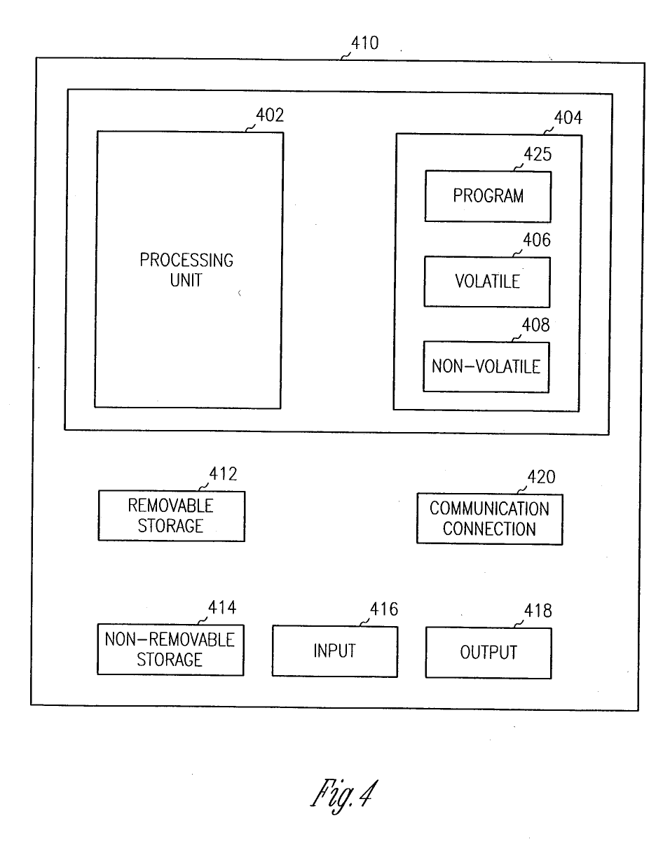

In further embodiments, a request comprises requests for multiple documents or subsets of information from one or multiple accounts. An alternative system for handling such requests is indicated in FIG. 3, which may also handle requests for a single document. A user system 310 running a local or remote application 315 again generates the request, which is communicated via the Internet or other network to selected document servers 325, 330 and 335. The specific document server may be identified in the request, routed upon receipt to a document server having bandwidth, or independently identified by address as the destination for the request.

The document server that receives the request, communicates with one or more source systems 340, 345 and 350 having account information for the user. Where the request identifies more than one account at different institutions utilizing different source systems, the request is divided, and sent via network 320 to such source systems. Answers back from the source systems are collated, and multiple documents are provided back to the user, either asynchronously, or at the same time.

In still further embodiments, the subsets of information are transferred to a separate repository for access. An application service provider (ASP) may be used as a secure central repository allowing a single point of access for users, without allowing full access to a hosting company's main system. Further, a central repository may be located at the hosting company site, allowing a single point of access for the user, without allowing full access to the main system. In further alternative embodiments, an on demand transfer of information from the hosting company's third party service bureau is provided to the user application.

A block diagram of a computer system that executes programming for performing the above algorithm is shown in FIG. 4. A general computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a computer-readable medium. For example, a computer program 425 capable of providing a generic technique to perform access control check for data access and/or for doing an operation on one of the servers in a COM based system according to the teachings of the present invention may be included on a CD-ROM and loaded from the CD-ROM to a hard drive. The computer-readable instructions allow computer system 400 to provide generic access controls in a COM based computer network system having multiple users and servers.

1. A method of populating a form on a user application, the method comprising:
receiving a key associated with an account, wherein the key only allows access to a desired subset of information in the account;
generating an account request identifying the key and the account;
sending the account request to a server for accessing the account; and
receiving the desired subset of information from the server.

2. The method of claim 1 wherein the key is received on an account statement.

3. The method of claim 2 wherein the account statement is sent electronically.

4. The method of claim 1 wherein the desired subset of information from the server is provided in the form of a document.

5. The method of claim 4 wherein the document is a financial document.

6. The method of claim 4 wherein the document is a tax related document.

7. The method of claim 6 wherein the tax document is defined by one of many open financial exchange protocols.

8. The method of claim 1 wherein the request further identifies at least one of a document server, document type, and document ID.

9. The method of claim 1 wherein the request further includes a check digit or digits.

10. The method of claim 1 wherein the request is securely encoded.

11. A method of accessing a subset of information in an account, the method comprising:
receiving an account request from a user identifying a key associated with the account, wherein the key only allows access to a desired subset of information in the account;
obtaining the desired subset of information from the account identified in the account request; and
sending the desired subset of information to the user.

12. The method of claim 11, and further comprising generating a document containing the desired subset of information prior to sending the information to the user.

13. The method of claim 12 wherein the account is associated with one or more tax reportable events, and wherein the document is comprised of one or more tax forms related to the tax reportable event(s).

14. The method of claim 13 wherein the tax form comprises a W-2/1099/1098 form.

15. The method of claim 11 wherein the account request comprises information identifying a desired document, an account, and the key.

16. The method of claim 11 wherein the key only allows access to information in the account sufficient to generate a desired tax related document.

17. The method of claim 16 wherein the document is readable by a machine.

18. A computer readable medium having instructions for causing a computer to perform a method of accessing a subset of information in an account, the method comprising:
receiving an account request from a user identifying a key associated with the account, wherein the key only allows access to a desired subset of information in the account;
obtaining the desired subset of information from the account identified in the account request; and
sending the desired subset of information to the user.

19. A computer readable medium having instructions for causing a computer to perform a method of populating a form on a user application, the method comprising:
receiving a key associated with an account, wherein the key only allows access to a desired subset of information in the account;
generating an account request identifying the key and the account;
sending the account request to a server for accessing the account; and
receiving the desired subset of information from the server.

20. A method of generating a request for information from an account hosted on a networked computer, the method comprising:
obtaining a key from a user, wherein the key provides access to a subset of information from the hosted account;
inserting the key and known account information into a request which is sent to a server; and
receiving the requested subset of information from the server.

21. The method of claim 20 wherein the request is encoded prior to being sent.

22. The method of claim 20 and further comprising generating a check sum for the request, and adding the checksum to the request.

23. The method of claim 20 wherein the requested subset of information is received as a tax form.

24. The method of claim 23 wherein the subset of information is used by a tax program to generate a tax return.

25. The method of claim 20 wherein obtaining a key comprises prompting a user to enter the key into a computer implementing the method.

26. The method of claim 25 wherein the account information is obtained from a financial program running on the computer.

27. A computer readable medium having instructions for performing a method of generating a request for information from an account hosted on a networked computer, the method comprising:
obtaining a key from a user, wherein the key provides access to a subset of information from the hosted account;
inserting the key and known account information into a request which is sent to a server; and
receiving the requested subset of information from the server.
